(19) United States
(12) Patent Application Publication
(10) Pub. No.: US 2020/0311902 A1
(43) Pub. Date: Oct. 1, 2020

(54) DATA PROCESSING APPARATUS, DATA ANALYSIS SYSTEM, DATA ANALYSIS METHOD AND STORAGE MEDIUM

(71) Applicant: Preferred Networks, Inc., Tokyo (JP)

(72) Inventor: Tatsuya TAKAMURA, Tokyo (JP)

(21) Appl. No.: 16/817,555

(22) Filed: Mar. 12, 2020

(30) Foreign Application Priority Data
Apr. 1, 2019 (JP) 2019-070126

(51) Int. Cl. G06T 7/00; G06T 9/00

(52) U.S. Cl. CPC G06T 7/0002; G06T 9/00; G06T 2207/20081; G06T 2207/20224; G06T 2207/20084; G06T 2207/20016

(57) ABSTRACT

One aspect of the present disclosure relates to a data processing apparatus including a reception unit that receives feature information from another data processing apparatus, wherein the feature information is obtained from first data, and the first data is obtained from to-be-processed data, an analysis unit that analyzes second data and the feature information, wherein the second data is obtained from the to-be-processed data, and an output unit that outputs data including an analysis result of the analysis unit.

### CROSS-REFERENCE TO RELATED APPLICATIONS

The present application is based on and claims priority to JP application No. 2019-070126 filed on Apr. 1, 2019 with the JPO, the entire contents of which are hereby incorporated by reference.

### BACKGROUND

### 1. Technical Field

The disclosure herein relates to a data processing apparatus, a data analysis system, a data analysis method and a data processing program.

### 2. Description of the Related Art

Conventionally, data analysis systems, where data analysis engines using neural networks are installed in servers and provide data analysis services to clients, are known. According to these systems, the data analysis services can be provided to users of the clients at inexpensive prices. Meanwhile, the systems have problems stemming from network communication with the servers.

### SUMMARY

One objective of the present disclosure is to provide a data processing apparatus, a data analysis system, a data analysis method and a data processing program that are novel for use of network communication.

One aspect of the present disclosure relates to a data processing apparatus, comprising: one or more memories; and one or more processors configured to: receive feature information from another data processing apparatus, wherein the feature information is obtained from first data that is obtained from to-be-processed data; analyze the feature information received from the other data processing apparatus and second data that is obtained from the to-be-processed data; and output data including an analysis result of the analyzing of the feature information and the second data.

Another aspect of the present disclosure relates to a data analysis system, comprising: a first data processing apparatus; and a second data processing apparatus, wherein the second data processing apparatus is configured to: receive feature information from the first data processing apparatus, wherein the feature information is obtained from first data that is obtained from to-be-processed data; analyze the feature information received from the first data processing apparatus and second data that is obtained from the to-be-processed data; and output data including an analysis result of the analyzing of the feature information and the second data.

A further aspect of the present disclosure relates to a non-transitory computer-readable storage medium for storing a program that causes one or more computers to perform operations, the operations comprising: receiving feature information from another data processing apparatus, wherein the feature information is obtained from first data that is obtained from to-be-processed data; analyzing the feature information received from the other data processing apparatus and second data that is obtained from the to-be-processed data; and outputting data including an analysis result of the analyzing of the feature information and the second data.

A still further aspect of the present disclosure relates to a data analysis method for a data analysis system including a first data processing apparatus and a second data processing apparatus, comprising: receiving, by one or more processors, feature information from the first data processing apparatus, wherein the feature information is obtained from first data that is obtained from to-be-processed data; analyzing, by the one or more processors, the feature information received from the first data processing apparatus and second data that is obtained from the to-be-processed data; and outputting, by the one or more processors, data including an analysis result of the analyzing of the feature information and the second data.

### BRIEF DESCRIPTION OF THE DRAWINGS

Other objects and further features of the present disclosure will be apparent from the following detailed description when read in conjunction with the accompanying drawings, in which:

FIG. 1 illustrates one exemplary system arrangement of a data analysis system according to one embodiment of the present disclosure;

FIGS. 2A and 2B illustrate exemplary hardware arrangements of a second data processing apparatus and a first data processing apparatus, respectively, according to one embodiment of the present disclosure;

FIG. 3 is a first schematic diagram for illustrating data analysis operations at the data analysis system according to one embodiment of the present disclosure;

FIG. 4 is a block diagram for illustrating one exemplary functional arrangement of a data processing unit of the second data processing apparatus according to one embodiment of the present disclosure;

FIG. 5 is a block diagram for illustrating one exemplary functional arrangement of an analysis service unit of the first data processing apparatus according to one embodiment of the present disclosure;

FIG. 6 is a first flowchart for illustrating data processing of the second data processing apparatus according to one embodiment of the present disclosure;

FIG. 7 is a second schematic diagram for illustrating data analysis operations at the data analysis system according to one embodiment of the present disclosure;

FIG. 8 is a second flowchart for illustrating data processing of the second data processing apparatus according to one embodiment of the present disclosure;

FIG. 9 is a third schematic diagram for illustrating data analysis operations at the data analysis system according to one embodiment of the present disclosure; and

FIG. 10 is a third flowchart for illustrating data processing of the second data processing apparatus according to one embodiment of the present disclosure.

### DETAILED DESCRIPTION

Embodiments are described below with reference to the accompanying drawings. Note that duplicated descriptions of components having the substantially same functional arrangements in the present specification and drawings may be omitted by attaching the same reference numerals.

### First Embodiment

### <System Arrangement of Data Analysis System>

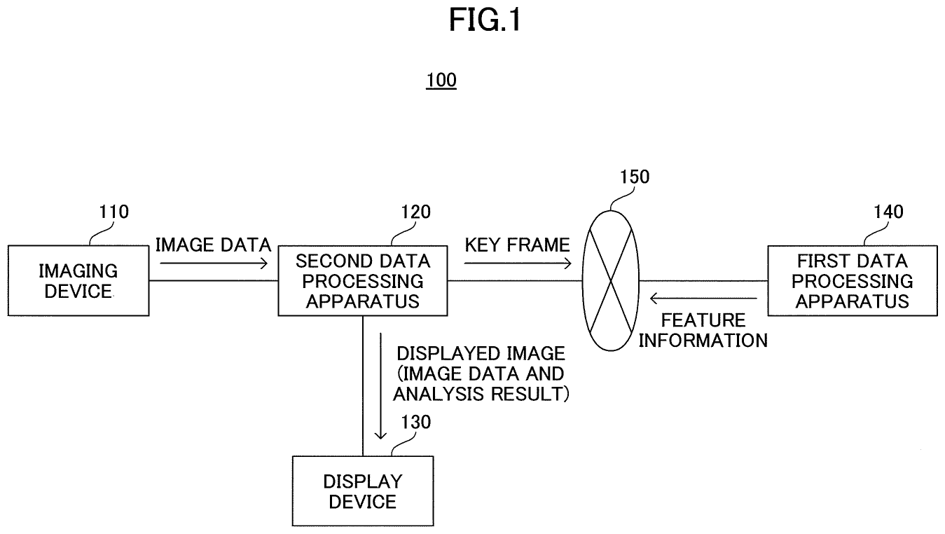

First, a system arrangement of a data analysis system according to a first embodiment is described. FIG. 1 illustrates an exemplary system arrangement of the data analysis system. As illustrated in FIG. 1, the data analysis system 100 according to this embodiment has an imaging device 110, a second data processing apparatus 120, a display device 130 and a first data processing apparatus 140. The second data processing apparatus 120 is communicatively coupled to the first data processing apparatus 140 via a network 150.

The imaging device 110 according to this embodiment performs photographing at a predetermined frame rate and sequentially transmits image data obtained in the photographing (time series data, where multiple frame images are arranged in time series, serving as to-be-processed data) to the second data processing apparatus 120. For example, the imaging device 100 may be a monitoring camera in the case where the first data processing apparatus 140 provides video analysis services for monitoring cameras. Also, the imaging device 100 may be a relaying camera in the case where the first data processing apparatus 140 provides video analysis services for sports broadcast. In other words, the imaging device 110 is one exemplary data acquisition apparatus for acquiring the to-be-processed data.

The second data processing apparatus 120 according to this embodiment has a client functionality. Also, the second data processing apparatus 120 according to this embodiment encodes image data transmitted from the imaging device 110 to generate encoded data. Also, the second data processing apparatus 120 according to this embodiment divides the generated encoded data to generate an I frame (Intra-coded frame) serving as a key frame. In addition, the second data processing apparatus 120 according to this embodiment divides the generated encoded data to generate a P frame (Predicted frame) or a B frame (Bi-directional Predicted frame) serving as a difference frame. Note that the I frame as the key frame is one example of the first data and the P frame or the B frame as the difference frame is one example of the second data.

Also, the second data processing apparatus 120 communicates with the first data processing apparatus 140. Specifically, the second data processing apparatus 120 transmits the I frame as the key frame to the first data processing apparatus 140 and receives feature information from the first data processing apparatus 140.

Also, the second data processing apparatus 120 analyzes the P frame or the B frame as the difference frame and the received feature information to obtain an analysis result. Furthermore, the second data processing apparatus 120 generates a displayed image including the image data and the analysis result and outputs the displayed image to the display device 130.

The display device 130 displays the displayed image fed from the second data processing apparatus 120. The displayed image displayed on the display device 130 includes the image data captured by the imaging device 110 and the analysis result from the second data processing apparatus 120. In other words, the display device 130 is one exemplary output device for outputting the to-be-processed data and the analysis result.

The first data processing apparatus 140 according to this embodiment has a server functionality. Also, the first data processing apparatus 140 analyzes I frames as key frames transmitted from the second data processing apparatus 120 to extract feature information. Furthermore, the first data processing apparatus 140 according to this embodiment transmits the extracted feature information to the second data processing apparatus 120.

### <Hardware Arrangements of Second Data Processing Apparatus and First Data Processing Apparatus>

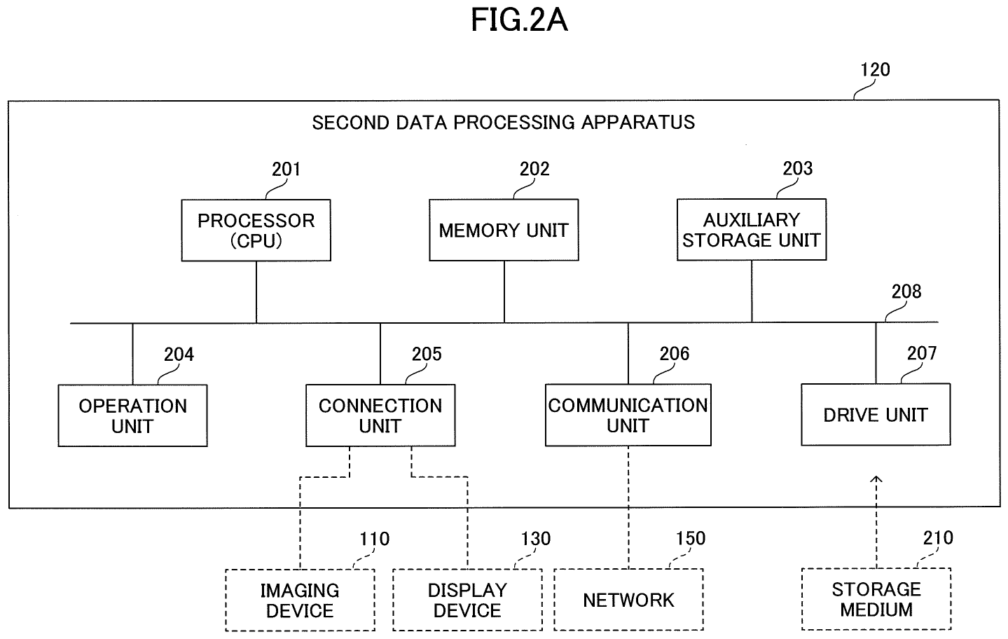

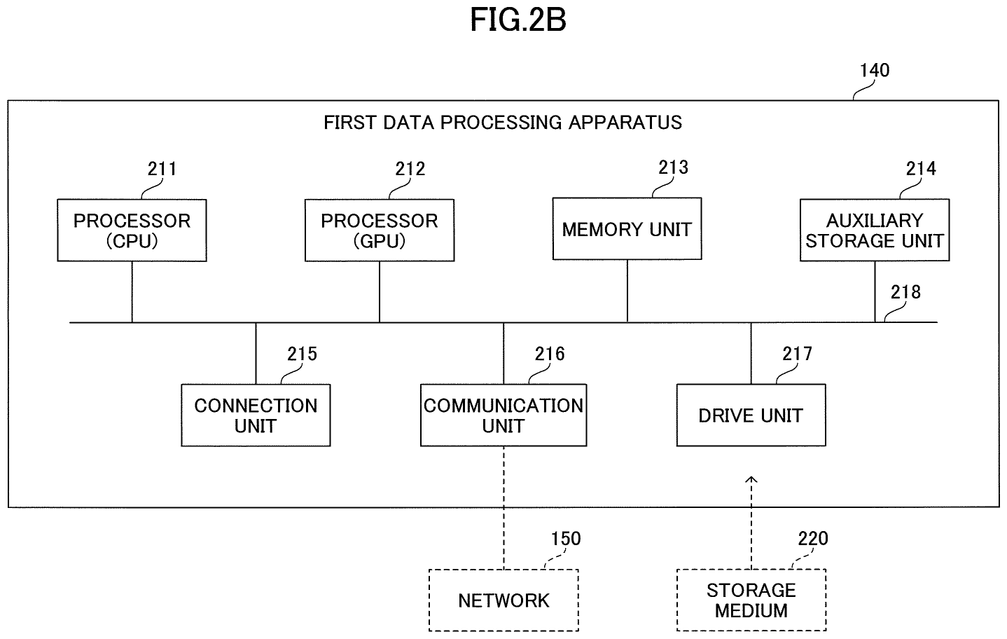

Next, hardware arrangements of the second data processing apparatus 120 and the first data processing apparatus 140 are described. FIGS. 2A and 2B illustrate exemplary hardware arrangements of the second data processing apparatus 120 and the first data processing apparatus 140, respectively.

### (1) Hardware Arrangement of Second Data Processing Apparatus

FIG. 2A illustrates one exemplary hardware arrangement of the second data processing apparatus 120. As illustrated in FIG. 2A, the second data processing apparatus 120 according to this embodiment has a processor 201, a memory unit 202, an auxiliary storage unit 203, an operation unit 204, a connection unit 205, a communication unit 206 and a drive unit 207. The second data processing apparatus 120 may be implemented as a computer composed of these components coupled via a bus 208.

In the example as illustrated in FIG. 2A, the second data processing apparatus 120 has a single entity for each of the components but may have a plurality of entities for the same component. Also, in the example as illustrated in FIG. 2A, the single second data processing apparatus 120 is illustrated, but a plurality of the second data processing apparatuses 120 may be included. In this case, software items (for example, a data processing program as stated below) may be installed in the plurality of the second data processing apparatuses 120, and the respective second data processing apparatuses 120 may perform different portions of the software items. Also, in this case, the respective second data processing apparatuses 120 may communicate with each other via network interfaces or the like.

The processor 201 may be an electronic circuit (a processing circuit or a processing circuitry) including an arithmetic unit such as a CPU (Central Processing Unit). The processor 201 performs arithmetic operations based on data or programs loaded from the components of the second data processing apparatus 120 to provide operation results or control signals to the components. Specifically, the processor 201 performs an OS (Operating System) or an application to control the components in the second data processing apparatus 120.

Note that the processor 201 is not limited to a specific processing circuit as long as the processor 201 can implement the above operations. Here, the processing circuit may be implemented with one or more electronic circuits mounted to two or more chips or devices. If the processing circuit is implemented with one or more electronic circuits, the respective electronic circuits may communicate with each other in a wired or wireless manner.

The memory unit 202 may be implemented with a storage device for storing electronic information such as instructions, programs and data executed by the processor 201. The electronic information stored in the memory unit 202 may be loaded by the processor 201. The auxiliary storage unit 203 may be implemented with one or more storage devices except the memory unit 202. Note that these storage devices may mean arbitrary electronic parts that can store the electronic information, for example, a memory or a storage. Also, the memory may be any of a volatile memory and a non-volatile memory. The memory for storing the electronic information in the second data processing apparatus 120 may be implemented with the memory unit 202 or the auxiliary storage unit 203.

The operation unit 204 may be implemented with an input device for a user of the second data processing apparatus 120 to input various instructions to the second data processing apparatus 120.

The connection unit 205 may be implemented with an interface for connecting to the imaging device 110 and the display device 130, for example, a USB (Universal Serial Bus). The communication unit 206 may be implemented with a communication bus for connecting to the network 150 for communication with the first data processing apparatus 140.

The drive unit 207 may be implemented with a device for setting a storage or recording medium 210. The storage medium 210 herein may include a medium for storing or recording information optically, electrically or magnetically, for example, a CD-ROM (Compact Disk-Read Only Memory), a flexible disk, an optical disk and so on. Also, the storage medium 210 may include a semiconductor memory or the like for storing or recording information electrically, for example, a ROM, a flash memory or the like.

Note that various programs installed in the auxiliary storage unit 203 may be installed by setting the distributed storage medium 210 to the drive unit 207 and loading the various programs stored in the storage medium 210 via the drive unit 207. Alternatively, the various programs installed in the auxiliary storage unit 203 may be installed by downloading from the network 150.

### (2) Hardware Arrangement of First Data Processing Apparatus

FIG. 2B illustrates one exemplary hardware arrangement of the first data processing apparatus 140. As illustrated in FIG. 2B, the first data processing apparatus 140 according to this embodiment has a processor 211, a processor 212, a memory unit 213, an auxiliary storage unit 214, a connection unit 215, a communication unit 216 and a drive unit 217. The first data processing apparatus 140 may be implemented as a computer composed of these components coupled via a bus 218.

The first data processing apparatus 140 may differ from the second data processing apparatus 120 as illustrated in FIG. 2A in that the first data processing apparatus 140 particularly has the processor 212 having a higher processing capability than the processor 201 of the second data processing apparatus 120 with respect to operations using NNs (Neural Networks), for example, a GPU (Graphics Processing Unit), a MN-Core or the like.

Note that similar to the second data processing apparatus 120 as illustrated in FIG. 2A, the example as illustrated in FIG. 2B illustrates the single first data processing apparatus 140, but the plurality of the first data processing apparatuses 140 may be included. In this case, software items (for example, an analysis service program) may be installed in the plurality of the first data processing apparatuses 140, and the respective first data processing apparatuses 140 may perform different portions of the software items.

Also, the other components of the first data processing apparatus 140 except the processor 212 may be similar to the corresponding components of the second data processing apparatus 120, and descriptions thereof may be omitted.

### <Overview of Data Analysis Operation>

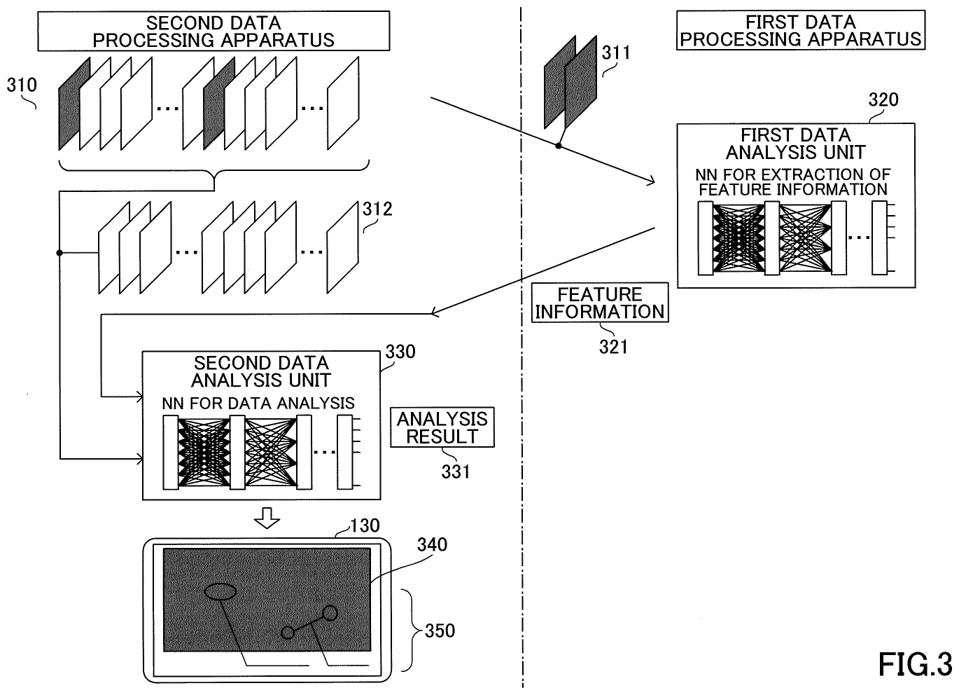

Next, an overview of data analysis operations in the data analysis system 100 is described. FIG. 3 is a first diagram for illustrating one exemplary overview of the data analysis operations in the data analysis system 100. In FIG. 3, the left side of the alternate long and short dashed line represents operations performed by the second data processing apparatus 120, and the right side represents operations performed by the first data processing apparatus 140.

As stated above, image data captured by the imaging device 110 is encoded at the second data processing apparatus 120. The greyed frames of the encoded data 310 as illustrated in FIG. 3 represent

I frames serving as key frames. On the other hand, the blank frames of the encoded data 310 represent P frames or B frames serving as difference frames. Note that if the image data captured by the imaging device 110 is captured at 60 fps, the I frames as the key frames may be provided at an interval of every one to three seconds, for example. Also, the P frames or the B frames as the difference frames may be output at an interval of every 0.1 second, for example. In other words, the second data may be generated at the shorter interval than the first data.

As illustrated in FIG. 3, the second data processing apparatus 120 transmits the key frames 311 (I frames) in the encoded data 310 to the first data processing apparatus 140. Here, the first data processing apparatus 140 has a first data analysis unit 320. The first data analysis unit 320 may be a data analysis engine using a first NN and include the NN for extraction of feature information.

As illustrated in FIG. 3, the feature information extraction NN outputs feature information 321 for the incoming key frames 311 (I frames). For example, the feature information 321 may be a feature vector indicative of a feature of the key frame 311 (I frame). Also, the first data processing apparatus 140 transmits the feature information 321 provided from the feature information extraction NN to the second data processing apparatus 120. Here, the second data processing apparatus 120 has a second data analysis unit 330. The second data analysis unit 330 may be a data analysis engine using a second NN and include the NN for data analysis. It is assumed that the data analysis NN is composed of a smaller NN architecture than the feature information extraction NN in the first data analysis unit 320.

As illustrated in FIG. 3, the data analysis NN generates an analysis result 331 for the difference frames 312 (P frames or B frames) and the feature information 321 as inputs. Note that when the difference frames 312 are fed to the data analysis NN, the second data analysis unit 330 may perform predetermined pre-processing for the difference frames 312.

Also, the second data processing apparatus 120 generates a displayed image as output data based on the analysis result 331 provided from the data analysis NN and the image data captured by the imaging device 110 and provides the displayed image to the display device 130. In this manner, the display device 130 displays the displayed image that may include the image data 340 and a description 350 representing the analysis result 331.

In this manner, according to the data analysis system 100 of this embodiment, the second data processing apparatus 120 generates the encoded data 310 based on the image data and divides the generated encoded data 310 to generate the key frames 311 and the difference frames 312. In addition, the second data processing apparatus 120 transmits the key frames 311 to the first data processing apparatus 140.

As a result, latency of network communication can be shortened compared to the case where the whole encoded data 310 is transmitted to the: first data processing apparatus 140. Also, since the key frames 311 are transmitted at an interval of every one to three seconds, for example, the second data processing apparatus 120 can analyze the difference frames 312 and the feature information 321 without being influenced by communication time ranging within the interval. Furthermore, the second data processing apparatus 120 can acquire the feature information 321 generated as a result of sophisticated processing on the key frames 311 at the first data processing apparatus 140 having a higher processing capability, which can achieve highly accurate analyses.

Also, according to the data analysis system 100, the second data processing apparatus 120 having a lower processing capability uses a smaller NN architecture to analyze the feature information 321 and the difference frames 312 as the second data having a smaller data amount than the key frames 311 as the first data. As a result, according to the data analysis system 100, the second data processing apparatus 120 can output an analysis result for the image data captured by the imaging device 110 at less latency.

In this manner, according to the data analysis system 100 of this embodiment, highly accurate data analyses can be achieved in real time.

### <Functional Arrangement of Second Data Processing Apparatus>

Next, a functional arrangement of the second data processing apparatus 120 is described. As stated above, a data processing program is installed in the second data processing apparatus 120, and the second data processing apparatus 120 can serve as a data processing unit through execution of the program.

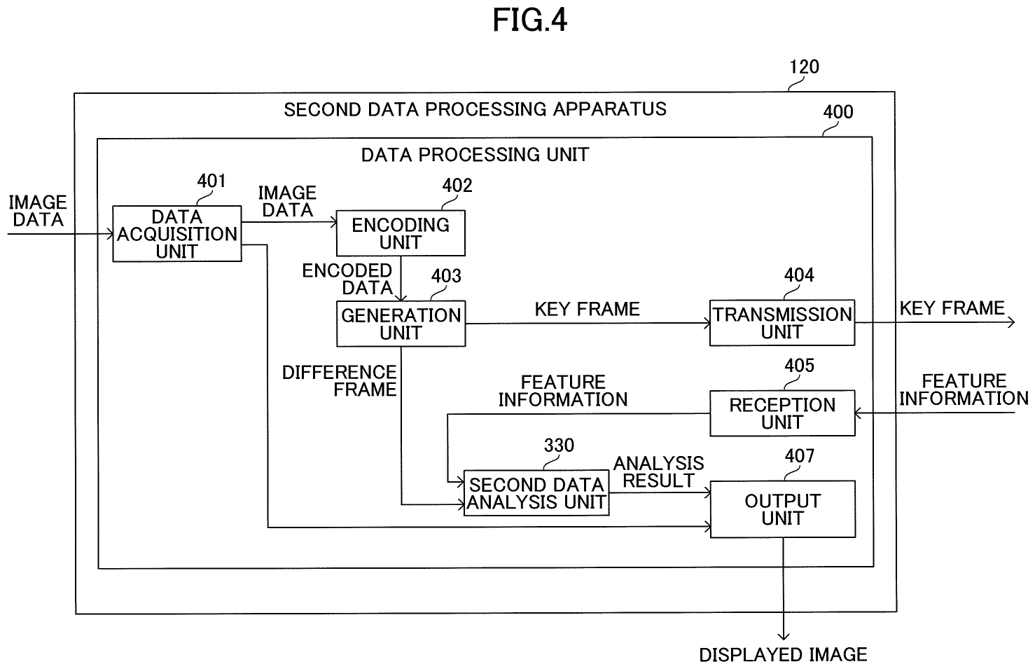

FIG. 4 illustrates one exemplary functional arrangement of a data processing unit of the second data processing apparatus 120. As illustrated in FIG. 4, the data processing unit 400 has a data acquisition unit 401, an encoding unit 402, a generation unit 403, a transmission unit 404, a reception unit 405, a second data analysis unit 330 and an output unit 407.

The data acquisition unit 401 acquires image data as to-be-processed data from the imaging device 110. Also, the data acquisition unit 401 transmits the acquired image data to the encoding unit 402 and the output unit 407.

The encoding unit 402 may be a processing unit for processing the acquired image data and encode the image data to generate encoded data in this embodiment. The encoded data generated by the encoding unit 402 include a key frame (I frame) as first data and a difference frame (P frame or B frame) as second data.

The generation unit 403 divides the encoded data generated by the encoding unit 402 to generate the key frame (I frame) and the difference frame (P frame or B frame). Also, the generation unit 403 transmits the key frame and the difference frame to the transmission unit 404 and the second data analysis unit 330, respectively.

The transmission unit 404 transmits the key frame received from the generation unit 403 to the first data processing apparatus 140 via the network 150.

In a reply to transmission of the key frame from the transmission unit 404 to the first data processing apparatus 140, the reception unit 405 receives feature information extracted at the first data processing apparatus 140 from the first data processing apparatus 140 via the network 150. Then, the reception unit 405 transmits the received feature information to the second data analysis unit 330. Note that the transmission unit 404 and the reception unit 405 may be collectively referred to as a communication unit.

The second data analysis unit 330 has the data analysis NN as stated above and performs the data analysis NN on the difference frames fed from the generation unit 403 and the feature information fed from the reception unit 405 as inputs. Also, the second data analysis unit 330 transmits an analysis result generated as an output of the data analysis NN to the output unit 407.

The output unit 407 generates a displayed image, including the image data from the data acquisition unit 401 and an analysis result (an analysis result for the image data) from the second data analysis unit 330, as output data. Also, the output unit 407 provides the generated displayed image to the display device 130. Accordingly, the display device can display the displayed image including the image data captured by the imaging device 110 and the analysis result generated as a result of analyzing the image data.

### <Functional Arrangement of First Data Processing Apparatus>

Next, a functional arrangement of the first data processing apparatus 140 is described. As stated above, an analysis service program is installed in the first data processing apparatus 140, and the first data processing apparatus 140 can serve as an analysis service unit through execution of the analysis service program.

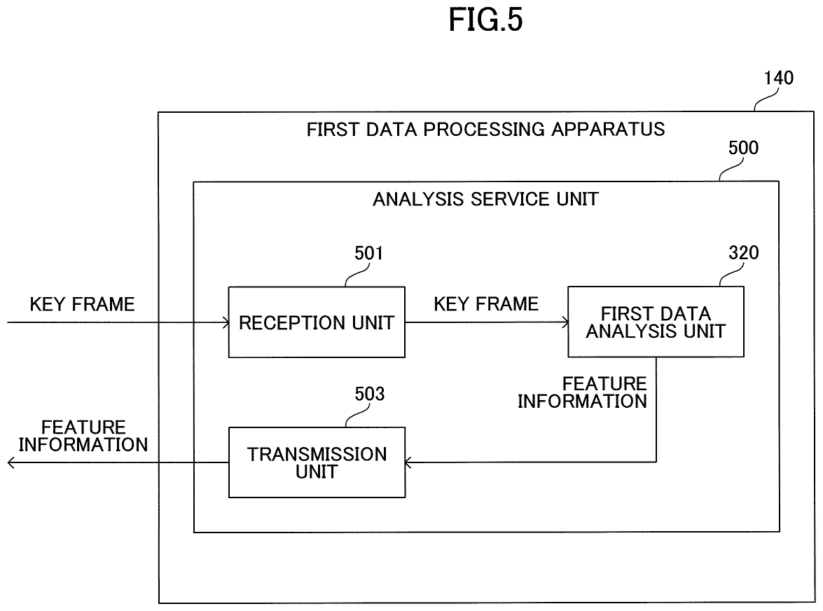

FIG. 5 illustrates one exemplary functional arrangement of the analysis service unit of the first data processing apparatus 140. As illustrated in FIG. 5, the analysis service unit 500 has a reception unit 501, a first data analysis unit 320 and a transmission unit 503.

The reception unit 501 receives a key frame as first data from the second data processing apparatus 120 via the network 150. Then, the reception unit 501 transmits the received key frame to the first data analysis unit 320.

The first data analysis unit 320 has the feature information extraction NN as states above and performs the feature information extraction NN for the incoming key frame from the reception unit 501. Also, the first data analysis unit 320 transmits the feature information generated as a result of performing the feature information extraction NN to the transmission unit 503.

The transmission unit 503 transmits the feature information fed from the first data analysis unit 320 to the second data processing apparatus 120 via the network 150.

### <Flow of Data Processing of Second Data Processing Apparatus>

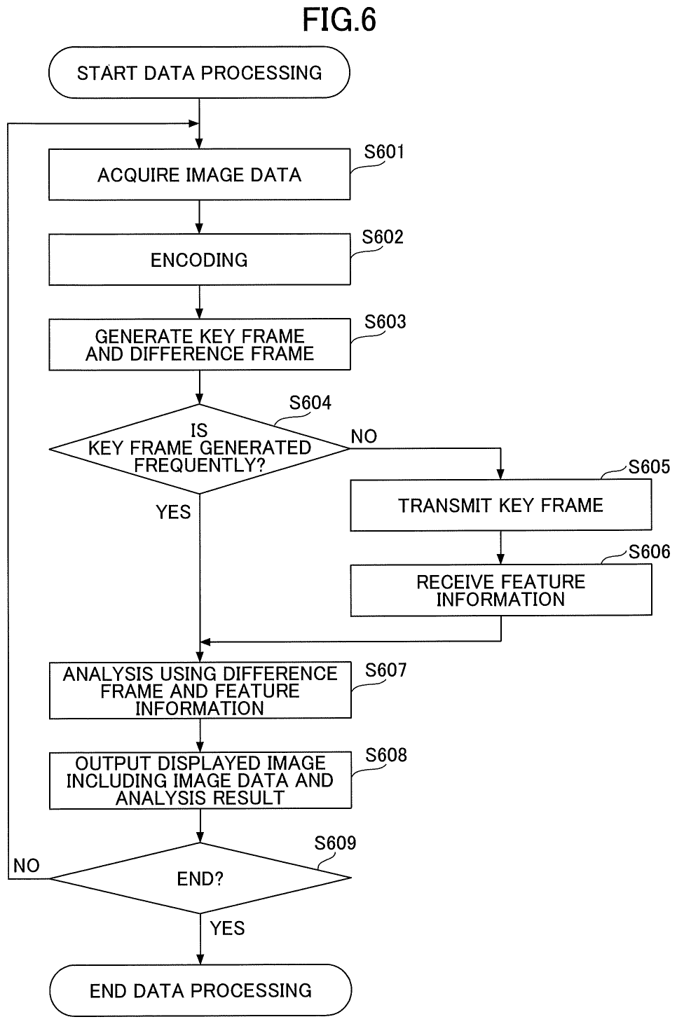

Next, the flow of data processing of the second data processing apparatus 120 is described. FIG. 6 is a first flowchart for illustrating the flow of data processing of the second data processing apparatus 120.

At step S601, the data acquisition unit 401 acquires image data from the imaging device 110.

At step S602, the encoding unit 402 encodes the acquired image data to generate encoded data.

At step S603, the generation unit 403 divides the encoded data to generate key frames and difference frames.

At step Z604, the generation unit 403 determines whether a frequency of generating the key frames is high (higher than a predetermined threshold). If it is determined at step S604 that the frequency of generating the key frames is high (S604: YES), the flow proceeds to step S607. On the other hand, if it is determined at step S604 that the frequency of generating the key frames is not high (S604: NO), the flow proceeds to step S605.

At step S605, the transmission unit 404 transmits the key frames to the first data processing apparatus 140.

At step S606, the reception unit 405 receives feature information from the first data processing apparatus 140.

At step S607, the second data analysis unit 330 performs analyses with the difference frames and the feature information and outputs an analysis result.

At step S608, the output unit 407 generates a displayed image including the acquired image data and the analysis result and provides the displayed image to the display device 130.

At step S609, the data acquisition unit 401 determines whether to finish the data processing, and if it is determined that the data processing is not finished (S609: NO), the flow returns to step S601. On the other hand, if it is determined at step S609 that the data processing is finished (S609: YES), the data processing is finished.

### <Exemplary Usage>

Next, some exemplary usages of the data analysis system 100 are described.

### (1) Exemplary Usage 1

The data analysis system 100 can be used to provide a video analysis service for sports broadcast. According to the data analysis system 100 of this embodiment, video data of a live game together with analysis results (for example, an analysis result of affinity among players, an analysis result of the degree of fatigue of the players or the like) can be displayed with less latency in almost real time.

In this case, the output unit 407 may transmit encoded displayed images to the display device 130, and the display device 130 may receive the encoded data and decode the received data for display. Also, selection as to whether to display the analysis results may be allowed at the display device 130. Furthermore, if the analysis results are displayed, only a portion of the analysis results may be allowed to be selectively displayed.

### (2) Exemplary Usage 2

The data analysis system 100 can be used to provide a video analysis service for monitoring cameras. According to the data analysis system 100, to-be-monitored video data together with analysis results (for example, an analysis result of features of suspicious people or the like) can be displayed with less latency in almost real time.

### (3) Exemplary Usage 3

The data analysis system 100 can provide a spatial analysis service to a robot working in a predetermined space, for example. According to the data analysis system 100, video data acquired from the robot as a result of capturing a working space is analyzed, and analysis results (for example, a spatial recognition result or the like) can be transmitted to the robot with less latency in almost real time. In this manner, the robot can recognize the space accurately in real time and work in the space.

### <Summary>

As can be seen in the above descriptions, the data analysis system according to the first embodiment includes the first data processing apparatus and the second data processing apparatus. Encoded data generated as a result of encoding the acquired image data is divided to generate key frames as first data and difference frames as second data. The key frames are transmitted to the first data processing apparatus, and feature information for the key frames is received from the first data processing apparatus. Analyses are performed with the difference frames and the feature information, and a displayed image including the acquired image data and an analysis result is generated. Furthermore, the generated displayed image is displayed.

As a result, according to the data analysis system of the first embodiment, latency of network communication can be shortened compared to the case where the whole encoded data is transmitted to the first data processing apparatus for analyses, and communication time can be less influenced. Also, according to the data analysis system of the first embodiment, the key frames are processed at the first data processing apparatus having a higher processing capability, and the difference frames and the feature information having smaller data amounts are processed at the second data processing apparatus having a lower processing capability. As a result, according to the data analysis system of the first embodiment, highly accurate data analyses can be achieved in real time.

In this manner, according to the first embodiment, a novel data processing apparatus, a novel data analysis system, a novel data analysis method and a novel data processing program using network communication can be provided.

### Second Embodiment

In the above first embodiment, the case where two types of data (key frame and difference frame) are generated as the first data and the second data has been described. However, generation of the first data and the second data is not limited to the above. For example, key image data and data indicative of the motion amount of an object in the key image data are generated as the first data and the second data, respectively, from image data serving as to-be-processed data. The second embodiment is described below mainly with respect to differences from the first embodiment.

### [Overview of Data Analysis Operation]

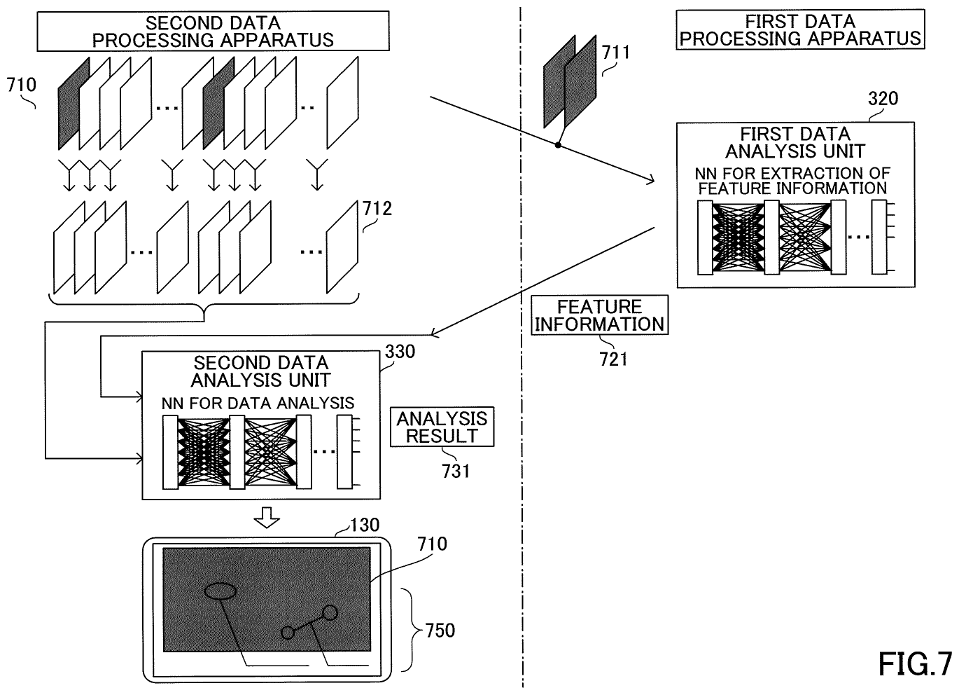

First, an overview of data analysis operations of the data analysis system 100 of the second embodiment is described. FIG. 7 is a second diagram for illustrating one exemplary overview of the data analysis operations of the data analysis system 100. Similar to FIG. 3, the left side of the alternate long and short dashed line represents operations performed by the second data processing apparatus 120, and the right side represents operations performed by the first data processing apparatus 140.

In the second embodiment, the second data processing apparatus 120 generates key image data as the first data and optical flow data as the second data based on image data 710 (to-be-processed data) captured by the imaging device 110. The optical flow data represents the motion of an object in the image data 710. In this embodiment, the key image data is the first data, and the optical flow data is the second data.

In FIG. 7, the greyed frames are the key image data as the first data and are extracted from the image data 710 captured by the imaging device 110 at a predetermined interval (for example, every one to three seconds). On the other hand, the blank frames in the image data other than the greyed frames are image data used to generate the optical flow data. If the image data captured by the imaging device 110 is image data of 60 fps, the key image data may be output at an interval of every one to three seconds, and the optical flow data may be output at an interval of every 0.1 second, for example. In other words, the second data is generated at the shorter interval than the first data.

In the second embodiment, the second data processing apparatus 120 uses the image data 710 to generate the optical flow data 712 as the second data. The optical flow data 712 is generated through calculation of the motion amount of an object based on immediately previous image data with respect to the time axis direction.

As illustrated in FIG. 7, the second data processing apparatus 120 transmits the key image data 711 in the image data 710 as the first data to the first data processing apparatus 140. Here, similar to FIG. 3, the first data processing apparatus 140 has a first data analysis unit 320, and the first data analysis unit 320 has a NN for extraction of feature information.

As illustrated in FIG. 7, the feature information extraction NN generates feature information 721 for the incoming key image data 711. The feature information 721 may be a feature vector indicative of a feature of the key image data 711, for example.

As illustrated in FIG. 7, the first data processing apparatus 140 transmits the feature information 721 fed from the feature information extraction NN to the second data processing apparatus 120. Here, similar to FIG. 3, the second data processing apparatus 120 has a second data analysis unit 330, and the second data analysis unit 330 has a NN for data analysis.

As illustrated in FIG. 7, upon receiving the feature information 721 and the optical flow data 712 as the second data as inputs, the data analysis NN outputs an analysis result 731.

Also, the second data processing apparatus 120 generates a displayed image as output data based on the analysis result 731 fed from the data analysis NN and the image data 710 captured by the imaging device 110 and provides the displayed image to the display device 130. Then, the display device 130 displays the displayed image including the image data 710 and a description 750 representing the analysis result 731.

In this manner, in the data analysis system 100 of the second embodiment, the second data processing apparatus 120 extracts key image data from the image data 710 and generates the optical flow data based on the image data 710. Also, in the data processing system 100 of the second embodiment, the second data processing apparatus 120 transmits the key image data 711 to the first data processing apparatus 140.

Accordingly, latency of network communication can be shortened compared to the case where the whole image data 710 is transmitted to the first data processing apparatus 140. Also, the key image data 711 may be transmitted at an interval of every one to three seconds, for example. As a result, the second data processing apparatus 120 can analyze the optical flow data 712 and the feature information 721 without being influenced by communication time ranging within the interval. Furthermore, the second data processing apparatus 120 can acquire the feature information 721 generated as a result of sophisticated operations on the key image data 711 at the first data processing apparatus 140 having a high processing capability, which can achieve highly accurate analyses.

Also, in the data analysis system 100 of the second embodiment, the second data processing apparatus 120 having a lower processing capability uses a small NN architecture to analyze the feature information 721 and the optical flow data 712 as the second data that has a smaller data amount than the first data. As a result, in the data analysis system 100 of the second embodiment, the second data processing apparatus 120 can output an analysis result for the image data captured by the imaging device 110 with less latency.

In this manner, according to the data analysis system 100 of the second embodiment, highly accurate data analyses can be achieved in real time.

### <Flow of Data Processing of Second Data Processing Apparatus>

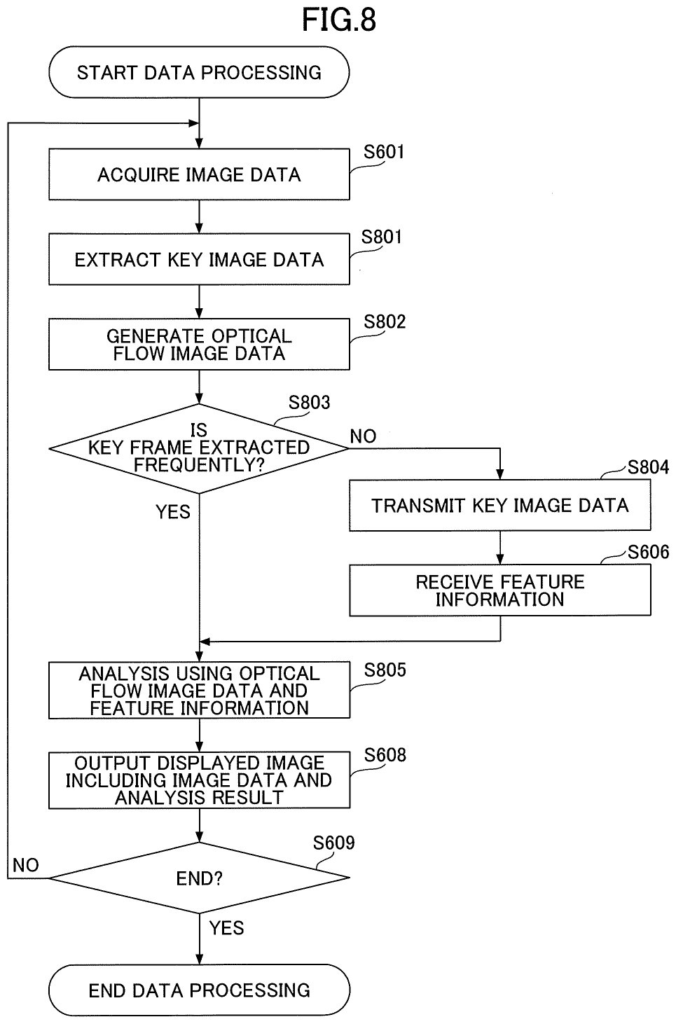

Next, the flow of data processing of the second data processing apparatus 120 according to the second embodiment is described. FIG. 8 is a second flowchart for illustrating the flow of data processing of the second data processing apparatus 120. Steps 5801 to 5804 and 5805 differ from the data processing in FIG. 6.

At step S801, the generation unit 403 extracts key image data from acquired image data.

At step S802, the generation unit 403 uses the acquired image data to generate optical flow data.

At step S803, the generation unit 403 determines whether a frequency of extracting the key image data is high (higher than a predetermined threshold). If it is determined at step S803 that the frequency of extracting the key image data is high (S803: YES), the flow proceeds to step S805. On the other hand, if it is determined at step S803 that the frequency of extracting the key image data is not high (S803: NO), the flow proceeds to step S804.

At step S804, the transmission unit 404 transmits the key image data to the first data processing apparatus 140.

At step S805, the second data analysis unit 330 performs analyses with the optical flow data and the feature information and output an analysis result.

### <Summary>

As can be seen in the above description, the data analysis system of the second embodiment has the first data processing apparatus and the second data processing apparatus. The key image data as the first data is extracted from the image data, and the optical flow data as the second data is generated based on the image data. The key image data is transmitted to the first data processing apparatus, and the feature information of the key image data is received from the first data processing apparatus. Analyses are performed with the optical flow data and the feature information, and a displayed image including the acquired image data and an analysis result is generated. Furthermore, the generated displayed image is displayed.

As a result, according to the data analysis system of the second embodiment, latency of network communication can be shortened compared to the case where the whole image data is transmitted to the first data processing apparatus for analysis, and communication time can be less influenced. Also, according to the data analysis system of the second embodiment, the key image data is processed by the first data processing apparatus having a higher processing capability, and the optical flow data and the feature information having smaller data amounts are processed by the second data processing apparatus having a lower processing capability. As a result, according to the data analysis system of the second embodiment, highly accurate data analyses can be achieved in real time.

In this manner, according to the second embodiment, a novel data processing apparatus, a novel data analysis system, a novel data analysis method and a novel data processing program using network communication can be provided.

### Third Embodiment

In the first and second embodiments, exemplary data generation at analyses performed by the second data processing apparatus 120 and the first data processing apparatus 140 based on image data as to-be-processed data has been described. In contrast, according to the third embodiment, data generation criteria at analyses performed by the second data processing apparatus 120 and the first data processing apparatus 140 based on the to-be-processed data are described.

### <Overview of Data Analysis Operation>

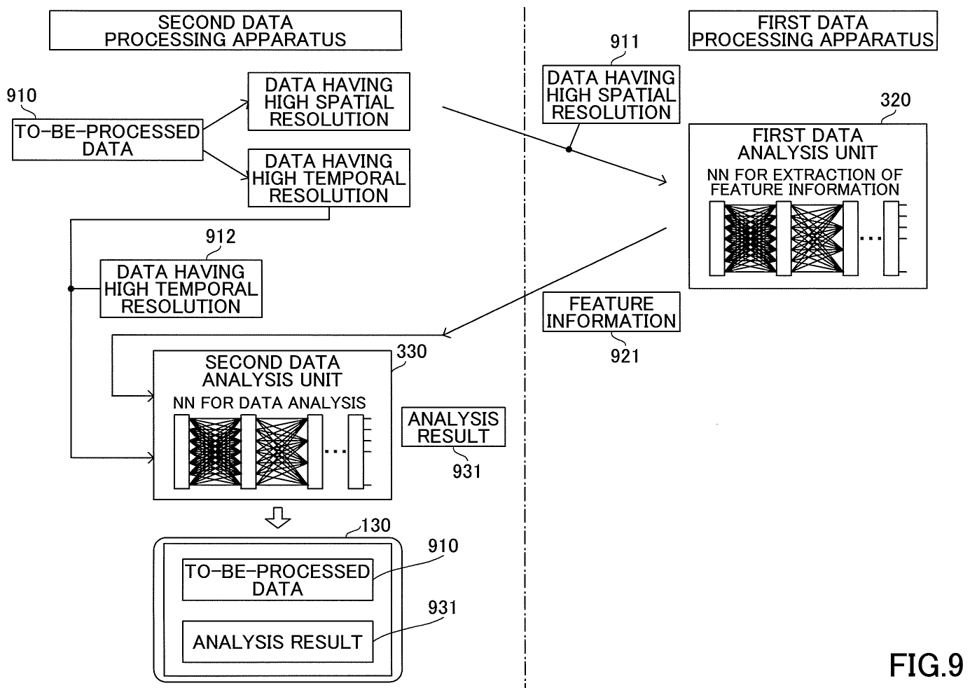

First, an overview of data analysis operations of the data analysis system 100 of the third embodiment is described. FIG. 9 is a third diagram for illustrating one exemplary overview of data analysis operations of the data analysis system. Similar to FIGS. 3 and 7, the left side of the alternate long and short dashed line represents operations performed by the second data processing apparatus 120, and the right side represents operations performed by the first data processing apparatus 140.

In the third embodiment, the second data processing apparatus 120 divides acquired to-be-processed data 910 to generate first data having a high spatial resolution and a low temporal resolution (first data having a first spatial resolution and a first temporal resolution) and second data having a low spatial resolution and a high temporal resolution (second data having a second spatial resolution and a second temporal resolution). Similar to the first and second embodiments, it is assumed that the first data may be output at an interval of every one to three seconds and the second data may be output at an interval of every 0.1 second, for example. In other words, the second data would be output at the shorter interval than the first data.

As illustrated in FIG. 9, the second data processing apparatus 120 transmits first data 911 in to-be-processed data 910 to the first data processing apparatus 140. Here, similar to FIGS. 3 and 7, the first data processing apparatus 140 has a first data analysis unit 320, and the first data analysis unit 320 has a NN for extraction of feature information.

As illustrated in FIG. 9, the feature information extraction NN outputs feature information 921 for the incoming first data 911. The feature information 921 may be a feature vector indicative of a feature of the first data 911.

As illustrated in FIG. 9, the first data processing apparatus 140 transmits the feature information 921 fed from the feature information extraction NN to the second data processing apparatus 120. Here, similar to FIGS. 3 and 7, the second data processing apparatus 120 has a second data analysis unit 330, and the second data analysis unit 330 has a NN for data analysis.

Also, the data analysis NN outputs an analysis result 931 for the second data 912 and the feature information 921 as inputs.

As illustrated in FIG. 9, the second data processing apparatus 120 generates output data based on the analysis result 931 from the data analysis NN and the to-be-processed data 910 and provides the output data to an output device (for example, the display device 130). As a result, the output data including the to-be-processed data 910 and the analysis result 931 is output in the output device.

In this manner, in the data analysis system 100 of the third embodiment, the second data processing apparatus 120 divides the to-be-processed data 910 to generate the first data 911 having a high spatial resolution and a low temporal resolution and the second data 912 having a low spatial resolution and a high temporal resolution. Also, in the data analysis system 100 of the third embodiment, the second data processing apparatus 120 transmits the first data 911 to the first data processing apparatus 140.

As a result, latency of network communication can be shortened compared to the case where the whole to-be-processed data 910 is transmitted to the first data processing apparatus 140. Also, since the first data 911 is transmitted at an interval of every one to three seconds, for example, the second data processing apparatus 120 can analyze the second data 912 and the feature information 921 without being influenced by communication time ranging within the interval.

Furthermore, the second data processing apparatus 120 can obtain the feature information 921 generated as a result of sophisticated operations performed on the first data 911 by the first data processing apparatus 140 having a high processing capability, which can achieve highly accurate analyses.

Also, in the data analysis system 100 of the third embodiment, the second data processing apparatus 120 having a low processing capability uses a small NN architecture to analyze the feature information and the second data 912 having a smaller data amount than the first data 911. As a result, in the data analysis system 100 of the third embodiment, the second data processing apparatus 120 can output an analysis result for the to-be-processed data 910 with low latency.

In this manner, according to the data analysis system 100 of the third embodiment, highly accurate data analyses can be achieved in real time.

### <Flow of Data Processing of Second Data Processing Apparatus>

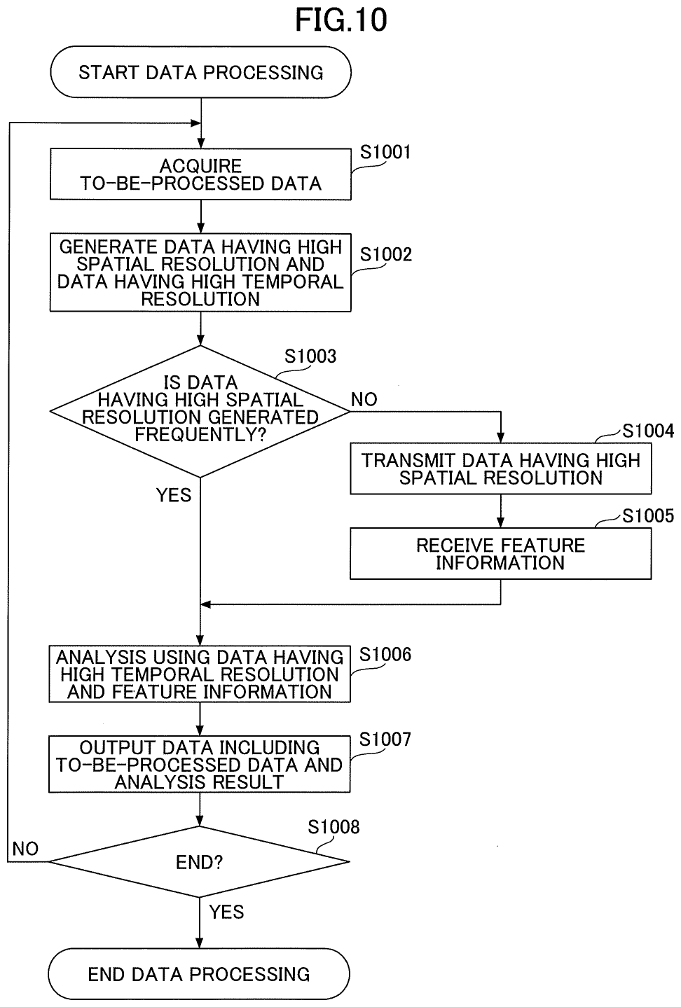

Next, the flow of data processing of the second data processing apparatus 120 of the third embodiment is described. FIG. 10 is a third flowchart for illustrating the flow of data processing of the second data processing apparatus.

At step S1001, the data acquisition unit 401 acquires to-be-processed data.

At step S1002, the generation unit 403 divides the to-be-processed data to generate first data having a high spatial resolution and a low temporal resolution and second data having a low spatial resolution and a high temporal resolution.

At step S1003, the generation unit 403 determines whether a frequency of generating the first data having the high spatial resolution and the low temporal resolution is high (higher than a predetermined threshold). If it is determined at step S1003 that the frequency of generating the first data is high (S1003: YES), the flow proceeds to step S1006. On the other hand, if it is determined at step S1003 that the frequency of generating the first data is not high (S1003: NO), the flow proceeds to step S1004.

At step S1004, the transmission unit 404 transmits the first data to the first data processing apparatus 140.

At step S1005, the reception unit 405 receives feature information from the first data processing apparatus 140.

At step S1006, the second data analysis unit 330 performs analyses with the second data and the feature information to generate an analysis result.

At step S1007, the output unit 407 generates output data including the acquired to-be-processed data and the analysis result and feeds the output data to the output device.

At step S1008, the data acquisition unit 401 determines whether to finish the data processing, and if it is determined that the data processing is not finished (S1008: NO), the flow returns to step S1001. On the other hand, it is determined at step S1008 that the data processing is finished (S1008: YES), the data processing is finished.

### <Summary>

As can be seen in the above description, the data analysis system of the third embodiment has the first data processing apparatus and the second data processing apparatus. The to-be-processed data is divided to generate the first data having a high spatial resolution and a low temporal resolution and the second data having a low spatial resolution and a high temporal resolution. The first data is transmitted to the first data processing apparatus, and the feature information of the first data is received from the first data processing apparatus. Analyses are performed with the second data and the feature information, and output data including the second data and the analysis result is generated. Furthermore, the generated output data is output.

As a result, according to the data analysis system of the third embodiment, latency of network communication can be shortened compared to the case where the whole to-be-processed data is transmitted to the first data processing apparatus for analysis, and communication time can be less influenced. Also, according to the data analysis system of the third embodiment, the first data is processed by the first data processing apparatus having a high processing capability, and the second data and the feature information having small data amounts are processed by the second data processing apparatus having a low processing capability. As a result, according to the data analysis system of the third embodiment, highly accurate data analyses can be achieved in real time.

In this manner, according to the third embodiment, a novel data processing apparatus, a novel data analysis system, a novel data analysis method and a novel data processing program using network communication can be provided.

### Fourth Embodiment

Although the to-be-processed data is time series image data in the above first and second embodiments, the to-be-processed data is not limited to the time series image data. For example, the to-be-processed data may be time series sound data. In this case, the second data processing apparatus 120 divides the time series sound data with respect to the time axis direction to generate first data and second data that have different time intervals.

Specifically, the second data processing apparatus 120 analyzes sound data having a short interval close to the current time point as the second data, and the first data processing apparatus 140 analyzes sound data having a long interval away from the current time point as the first data. In this manner, effects similar to the above first and second embodiments can be enjoyed.

Also, although the to-be-processed data is time series image data in the above first and second embodiments, the to-be-processed data is not limited to the time series image data. For example, the to-be-processed data may be not such time series data but data including types of data other than image. data (for example, data for automatic illustration coloring including line drawing data and color hint information). In this case, the second data processing apparatus 120 transmits the line drawing data as the first data to the first data processing apparatus 140 to acquire the feature information. Also, the second data processing apparatus 120 performs analyses with the feature information fed from the first data processing apparatus 140 and the color hint information to perform automatic coloring on the line drawing data. As a result, effects similar to the above first and second embodiments can be enjoyed.

### Other Embodiments

The above embodiments where the functionality of the data processing unit 400 is implemented by the processor 201 running the data processing programs have been described. However, the functionality of the data processing unit 400 may be implemented with one or more circuits formed of an analog circuit, a digital circuit or an analog and digital mixture circuit. Also, a control circuit for implementing the functionality of the data processing unit 400 may be provided. Implementations of the respective circuits may be an ASIC (Application Specific Integrated Circuit), a FPGA (Field Programmable Gate Array) or the like.

Also, in the above embodiments, the data processing programs may be executed by causing a computer to load the data processing programs from a storage or recording medium, such as a flexible disk or a CD-ROM, that stores the data processing programs. The storage medium is not limited to removable types of media such as a magnetic disk or an optical disk, and fixed types of storage media such as a hard disk device or a memory may be used. Also, operations by software may be implemented in one or more circuits such as a FPGA and may be performed with hardware items.

Also, although the output data fed from the output device has not been described in detail in the above embodiments, various implementations of the output data fed from the output device may be considered. For example, the output data may be operation instructions for a robot, a computer or the like or vocal announcements, instead of images or videos in the first embodiment.

Also, although the above embodiments where the data acquisition device (for example, the imaging device) and the output device (for example, the display device) are provided on the outside of the second data processing apparatus have been described, they may be attached to the second data processing apparatus 120. For example, the second data processing apparatus 120 may be a terminal such as a tablet, a robot or the like and include the imaging device as the data acquisition device and the display device as the output device.

Also, the above embodiments where the first data processing apparatus has server functionalities and the second data processing apparatus has client functionalities have been described. However, the first data processing apparatus and the second data processing apparatus are not limited to apparatuses having the server functionalities or the client functionalities. For example, the first data processing apparatus may be a computer provided in a home, and the second data processing apparatus may be a terminal coupled to the computer such as a smartphone, a tablet or the like.

Also, although the above embodiments where the first data analysis unit and the second data analysis unit has respective neural networks have been described, the first data analysis unit and the second data analysis unit may have other types of machine learning models. In other words, the first data analysis unit may have any other appropriate type of model that can output feature information for the incoming first data, and the second data analysis unit may have any other appropriate type of model that can output an analysis result for the feature information and the second data as inputs.

Also, data to be processed by the first data processing apparatus and the second data processing apparatus may be generated such that the respective apparatuses can appropriately process the data with desired efficiency. In other words, latency, a real time property, processing capability of the second data processing apparatus, a desired standpoint or the like may be considered at generating the first data and the second data from to-be-processed data.

Also, in the above embodiments, both the generation unit and the second data analysis unit are provided in the second data processing apparatus, but the respective units may be provided in two or more different apparatuses. For example, an apparatus having the generation unit may be provided between the imaging device and an apparatus having the second data analysis unit. In this case, the collection of the two apparatuses may be referred to as the second data processing apparatus in the specification.

The present disclosure is not limited to the above-stated specific embodiments, and various variations and modifications can be made without deviating from the scope of claims.

What is claimed is:

1. A data processing apparatus, comprising:
one or more memories; and
one or more processors configured to:
receive feature information from another data processing apparatus, wherein the feature information is obtained from first data that is obtained from to-be-processed data;
analyze the feature information received from the other data processing apparatus and second data that is obtained from the to-be-processed data; and
output data including an analysis result of the analyzing of the feature information and the second data.

2. The data processing apparatus as claimed in claim 1, wherein the one or more processors are further configured to:
obtain the first data and the second data from the to-be-processed data; and
transmit the first data to the other data processing apparatus to obtain the feature information.

3. The data processing apparatus as claimed in claim 2, wherein the second data is not transmitted to the other data processing apparatus, a data size of the first data that is obtained from the to-be-processed data and is transmitted to the other data processing apparatus being larger than the second data that is obtained from the to-be-processed data and is not transmitted to the other data processing apparatus.

4. The data processing apparatus as claimed in claim 2, wherein the first data has a first spatial resolution and a first temporal resolution, and the second data has a second spatial resolution lower than the first spatial resolution and a second temporal resolution higher than the first temporal resolution.

5. The data processing apparatus as claimed in claim 2, wherein the to-be-processed data is image data, and the one or more processors are configured to divide encoded data to generate a key frame as the first data and a difference frame as the second data, wherein the encoded data is generated by encoding the image data.

6. The data processing apparatus as claimed in claim 2, wherein the to-be-processed data is image data, and the one or more processors are configured to generate key image data as the first data through extraction from the image data at a predetermined cycle and generate optical flow data as the second data based on the image data.

7. The data processing apparatus as claimed in claim 1, wherein the other data processing apparatus analyzes the first data transmitted from the data processing apparatus to extract the feature information and transmits the extracted feature information to the data processing apparatus.

8. The data processing apparatus as claimed in claim 1, wherein the other data processing apparatus has a higher processing capability than the data processing apparatus.

9. The data processing apparatus as claimed in claim 1, wherein the analyzing of the feature information and the second data analyzes the feature information and the second data together.

10. The data processing apparatus as claimed in claim 1, wherein the one or more processors performs the analyzing of the feature information and the second data, using a neural network having the feature information and the second data as an input.

11. The data processing apparatus as claimed in claim 1, wherein the output data including the analysis result is displayed on a display device.

12. The data processing apparatus as claimed in claim 1, wherein the analysis of the feature information and the second data and the outputting of the data including the analysis result are performed in real time.

13. The data processing apparatus as claimed in claim 1, wherein the feature information received from the other data processing apparatus indicates a feature of the first data that is obtained from the to-be-processed data.

14. The data processing apparatus as claimed in claim 1, wherein the data processing apparatus has a machine learning model used for analyzing the feature information and the second data, and the other data processing apparatus has another machine learning model used for analyzing the first data to obtain the feature information.

15. The data processing apparatus as claimed in claim 14, wherein a model size of the machine learning model for the feature information and the second data of the data processing apparatus is smaller than the other machine learning model for the first data of the other data processing apparatus.

16. The data processing apparatus as claimed in claim 15, wherein the machine learning model of the data processing apparatus and the other machine learning model of the other data processing apparatus are neural network models. 10

17. The data processing apparatus as claimed in claim 1, wherein the feature information received from the other data processing apparatus is a feature vector indicative of the first data.

18. The data processing apparatus as claimed in claim 1, wherein the to-be-processed data is encoded data encoded from video data, the encoded data including a first number of key frames and a second number of difference frames, and the first number being smaller than the second number, and
wherein the first data is a key frame and the second data is a difference frame corresponding to the key frame.

19. A non-transitory computer-readable storage medium for storing a program that causes one or more computers to perform operations, the operations comprising:
receiving feature information from another data processing apparatus, wherein the feature information is obtained from first data that is obtained from to-be-processed data;
analyzing the feature information received from the other data processing apparatus and second data that is obtained from the to-be-processed data; and
outputting data including an analysis result of the analyzing of the feature information and the second data.

20. A data processing apparatus comprising:
one or more memories; and
one or more processors configured to:
receive, from another data processing apparatus, first data that is obtained from to-be-processed data;
analyze the first data received from the other data processing apparatus to obtain feature information; and
transmit, to the second data processing apparatus, the feature information that is obtained from the first data received from the other data processing apparatus,
wherein the transmitted feature information obtained from the first data that is obtained from the to-be-processed data is to be analyzed together with second data that is obtained from the to-be-processed data.
